(19) United States
(12) Patent Application Publication
(10) Pub. No.: US 2006/0287469 A1
(43) Pub. Date: Dec. 21, 2006

(54) Copolymer for semiconductor lithography, composition and thiol compound

(76) Inventors: Minoru Iijima, Chiba (JP); Takanori Yamagishi, Chiba (JP)

Correspondence Address: Melvin I. Stoltz Esq., 51 Cherry Street, Milford, CT, 06460, US

(21) Appl. No.: 11/444,780

(22) Filed: Jun. 1, 2006

(30) Foreign Application Priority Data
Jun. 3, 2005 (JP) 163775/2005

(51) Int. Cl. C08G 63/00

(52) U.S. Cl. 528/176

(57) ABSTRACT

The present invention provides a copolymer for semiconductor lithography, comprising: at least, a recurring unit (A) having a structure wherein an alkali-soluble group has been protected with an acid-dissociating, dissolution-suppressing group, and
a terminal structure (F) represented by the following formula (F): 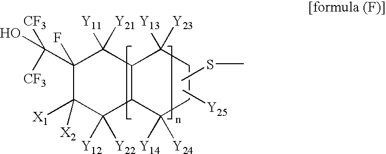
(wherein X₁ and X₂ are each independently a hydrogen atom, a halogen atom or a hydrocarbon group of 1 to 4 carbon atoms which may be substituted with halogen atom; Y₁₁ to Y₁₄ are a hydrogen atom, or an ether bond or a hydrocarbon bond of 1 to 2 carbon atoms, each formed between Y₁₁ and Y₁₂ or between Y₁₃ and Y₁₄; Y₂₁ to Y₂₅ are each independently a hydrogen atom or a hydrocarbon group of 1 to 4 carbon atoms; and n is an integer of 0 or 1); a composition containing the copolymer; and a thiol compound giving the copolymer. The copolymer of the present invention, when used in semiconductor lithography, is superior in lithography properties such as development contrast, DOF and the like.

### BACKGROUND OF THE INVENTION

1. Field of the Invention

The present invention relates to a copolymer for the lithography used in semiconductor production, a composition containing the copolymer, and a thiol compound giving the copolymer. More particularly, the present invention relates to a copolymer for semiconductor lithography, suitably used for fine processing using a radiation such as far ultraviolet radiation, X-rays, electron beam or the like, a composition containing the copolymer, and a thiol compound giving the copolymer.

2. Description of the Prior Art

In the lithography employed for semiconductor production, formation of a finer pattern is necessary with an increase in integration degree. In the formation of a fine pattern, a light source of short wavelength is essential. Currently, a lithography using a Krypton fluoride (KrF) excimer laser beam (wavelength: 248 nm) is the main lithography used in semiconductor mass production and, also, a lithography using an argon fluoride (ArF) excimer laser beam (wavelength: 193 nm) is being introduced in semiconductor mass production. Further, lithographies using a fluorine dimer (F₂) excimer laser beam (wavelength: 157 nm), extreme ultraviolet radiation (EUV), X-rays, electron beam or the like are being developed.

The resist polymers used in these lithographies are constituted so as to contain the following recurring units:

a recurring unit having a structure wherein a polar group soluble in alkaline developing solution (the group may be hereinafter referred to as alkali-soluble group) has been protected with an acid-dissociating, non-polar substituent group for suppressing the solubility in alkaline developing solution (the substituent group may be hereinafter referred to as acid-dissociating, dissolution-suppressing group),

a recurring unit having a polar group for increasing the adhesivity to semiconductor substrate or the like (these two recurring units are essential recurring units), and, as necessary,

a recurring unit having a polar or non-polar substituent group for controlling the solubility in resist solvent or alkaline developing solution.

In, for example, the lithography using a KrF excimer laser beam as the light source, there are known copolymers having a recurring unit derived from hydroxystyrene, and, a recurring unit wherein a phenolic hydroxyl group derived from hydroxystyrene has been protected with an acid-dissociating, dissolution-suppressing group or a recurring unit wherein a carboxyl group derived from (meth)acrylic acid has been protected with an acid-dissociating, dissolution-suppressing group or the like (reference is made to, for example, Patent Literatures 1 to 4). There are also known copolymers having a recurring unit using an alicyclic hydrocarbon group as an acid-dissociating, dissolution-suppressing group for increasing the dry etching resistance and the dissolution contrast between exposed area and non-exposed area (reference is made to, for example, Patent Literatures 5 to 6).

In the lithography using an ArF excimer laser beam of shorter wavelength or the like as the light source, there was investigated a copolymer having no recurring unit derived from hydroxystyrene having a high absorptivity coefficient to a wavelength of 193 nm. As a result, there are known copolymers having, in the recurring unit, a lactone structure as a polar group for increasing the adhesivity to semiconductor substrate or the like (reference is made to, or example, Patent Literatures 7 to 10), and copolymers having, in the recurring unit, a polar group-containing, alicyclic hydrocarbon group (reference is made to, for example, Patent Literature 11).

Also, in order to respond to the requirement for finer processing, there are known copolymers having, in addition to recurring units, a substituted or non-substituted polar group such as hydroxyl group, carboxyl group, amino group, carbamoyl group, hydroxyimino group or the like at the terminal of molecular chain (reference is made to, for example, Patent literatures 12 to 14). There are further known, for example, copolymers having a lactone structure at the terminal of molecular chain (reference is made to, for example, Patent Literature 15), or copolymers having a structure wherein a saturated hydrocarbon group has been substituted with a 2-hydroxy-1,1,1,3,3,3-hexafluoro-2-propylidene group (reference is made to, for example, Patent Literature 16).

Any of the above copolymers, however, has been unable to satisfy lithography properties in, for example, development contrast (which is an inclination of a curve of dissolution rate in alkaline developing solution, to applied light energy and can be indicated by a parameter such as tan θ or the like) and depth of focus (hereinafter abbreviated to DOF), both required for fine processing in semiconductor lithography.

Patent Literature 1: JP-A-1984-045439

Patent Literature 2: JP-A-1993-113667

Patent Literature 3: JP-A-1998-026828

Patent Literature 4: JP-A-1987-115440

Patent Literature 5: JP-A-1997-073173

Patent Literature 6: JP-A-1998-161313

Patent Literature 7: JP-A-1997-090637

Patent Literature 8: JP-A-1998-207069

Patent Literature 9: JP-A-2000-026446

Patent Literature 10: JP-A-2001-242627

Patent Literature 11: JP-A-1999-109632

Patent Literature 12: JP-A-1998-055069

Patent Literature 13: JP-A-2000-019737

Patent Literature 14: JP-A-2002-020424

Patent Literature 15: JP-A-2004-250377

Patent literature 16: JP-A-2004-292428

### SUMMARY OF THE INVENTION

The present invention has been made in view of the above-mentioned prior art. The present invention aims at providing a copolymer superior in semiconductor lithography in development contrast, DOF, etc.; a composition containing the copolymer; and a thiol compound giving the copolymer.

In order to achieve the above aims, the present inventors made a study. As a result, it was found that the above aims can be achieved by a copolymer for semiconductor lithography, comprising:

at least, a recurring unit (A) having a structure wherein an alkali-soluble group has been protected with an acid-dissociating, dissolution-suppressing group, and

a terminal structure (F) represented by formula (F); a composition containing the copolymer; and a thiol compound giving the copolymer. The finding has led to the completion of the present invention.

According to the present invention, there is provided a copolymer for semiconductor lithography, comprising: at least,

a recurring unit (A) having a structure wherein an alkali-soluble group has been protected with an acid-dissociating, dissolution-suppressing group, and

a terminal structure (F) represented by the following formula (F): 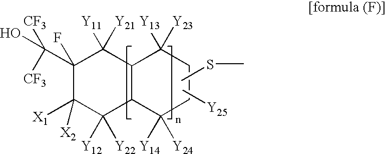
(wherein X₁ and X₂ are each independently a hydrogen atom, a halogen atom or a hydrocarbon group of 1 to 4 carbon atoms which may be substituted with halogen atom; Y₁₁ to Y₁₄ are a hydrogen atom, or an ether bond or a hydrocarbon bond of 1 to 2 carbon atoms, each formed between Y₁₁ and Y₁₂ or between Y₁₃ and Y₁₄; Y₂₁ to Y₂₅ are each independently a hydrogen atom or a hydrocarbon group of 1 to 4 carbon atoms; and n is an integer of 0 or 1).

According to the present invention, there is further provided a composition for semiconductor lithography, comprising the above copolymer for semiconductor lithography and a radiation-sensitive, acid-generating agent.

According to the present invention, there is furthermore provided a thiol compound represented by the following formula (f): 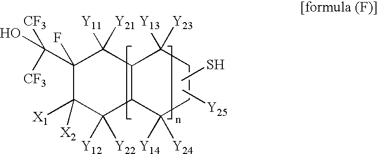
(wherein X₁ and X₂ are each independently a hydrogen atom, a halogen atom or a hydrocarbon group of 1 to 4 carbon atoms which may be substituted with halogen atom; Y₁₁ to Y₁₄ are a hydrogen atom, or an ether bond or a hydrocarbon bond of 1 to 2 carbon atoms, each formed between Y₁₁ and Y₁₂ or between Y₁₃ and Y₁₄; Y₂₁ to Y₂₅ are each independently a hydrogen atom or a hydrocarbon group of 1 to 4 carbon atoms; and n is an integer of 0 or 1).

By using the copolymer for semiconductor lithography according to the present invention, there can be provided a composition for semiconductor lithography, which is superior in lithography properties such as development contrast, DOF and the like; and by using the composition, there can be obtained a fine and good lithography pattern suitably used in production of semiconductor.

### BRIEF DESCRIPTION OF THE DRAWINGS

FIG. 1 is charts each showing a mass spectrum (GC-MS) of the chain transfer agent V obtained in Example 1, wherein the charts of mass spectra of individual peaks in gas chromatograph are shown below the gas chromatograph chart shown at the top. M/z: 312 (M⁺)

FIG. 2 is a ¹H-NMR chart of the chain transfer agent V obtained in Example 1.

FIG. 3 is a ¹³C-NMR chart of the chain transfer agent V obtained in Example 1.

### DETAILED DESCRIPTION OF THE INVENTION

As described above, the copolymer for semiconductor lithography according to the present invention comprises at least, a recurring unit (A) having a structure wherein an alkali-soluble group has been protected with an acid-dissociating, dissolution-suppressing group, and a terminal structure (F) represented by the formula (F). The copolymer of the present invention preferably comprises a recurring unit (C) having a lactone structure and more preferably comprises a recurring unit (D) having an acid-stable, alicyclic hydrocarbon group.

In the following formula (F) representing the terminal structure of the copolymer for semiconductor lithography according to the present invention, 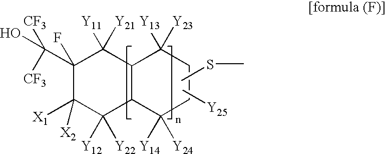
X₁ and X₂ are each independently a hydrogen atom, a halogen atom or a hydrocarbon group of 1 to 4 carbon atoms which may be substituted with halogen atom; Y₁₁ to Y₁₄ are a hydrogen atom, or an ether bond or a hydrocarbon bond of 1 to 2 carbon atoms, each formed between Y₁₁ and Y₁₂ or between Y₁₃ and Y₁₄; Y₂₁ to Y₂₅ are each independently a hydrogen atom or a hydrocarbon group of 1 to 4 carbon atoms; and n is an integer of 0 or 1.

The terminal structure (F) can be introduced by a step [hereinafter referred to as step (P)] of radical-polymerizing at least, a monomer giving the recurring unit (A), in an organic solvent using, as a chain transfer agent, a thiol compound of the present invention, represented by the following formula (f): 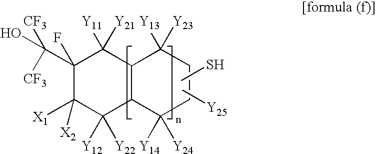
Incidentally, the substituent groups, etc. in the formula (f), such as X₁ and the like are the same as those in the formula (F).

As specific examples of the compound of the formula (f), there can be mentioned thiol compounds shown below. They can be used singly or in combination of two or more kinds.

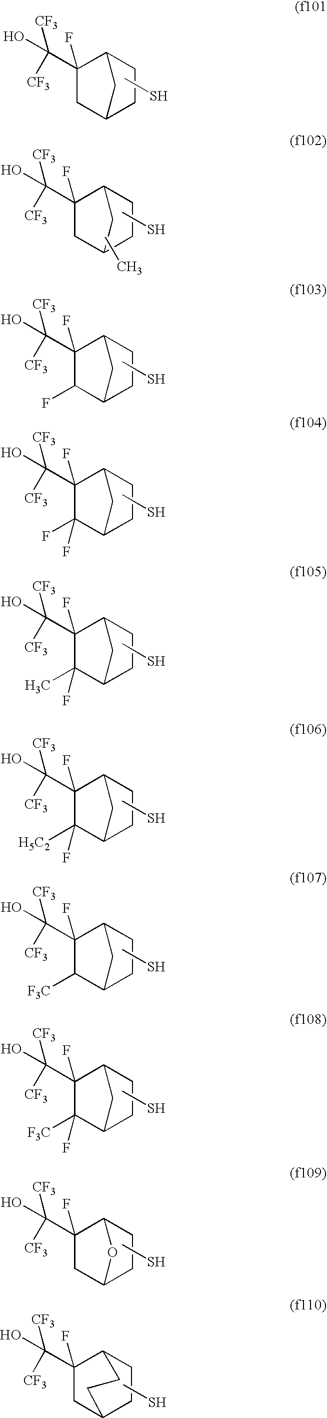

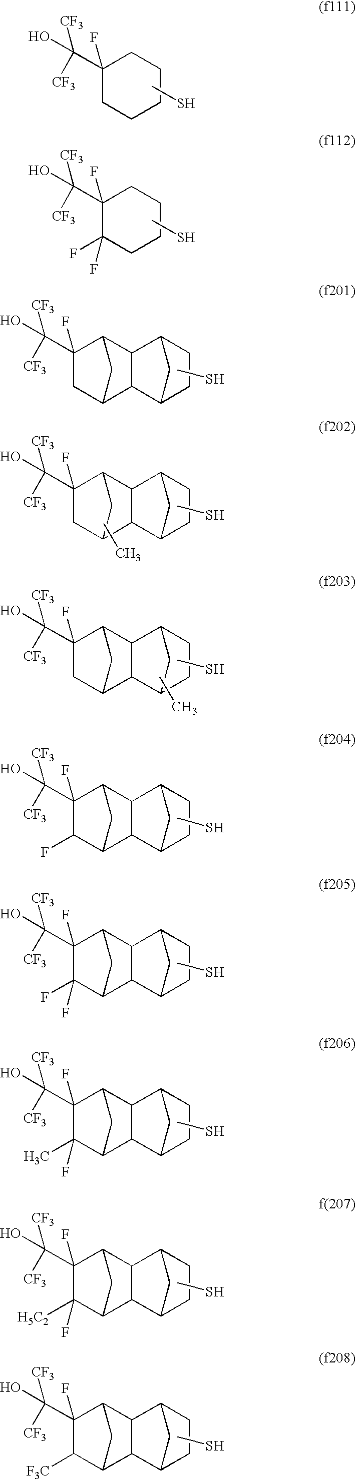

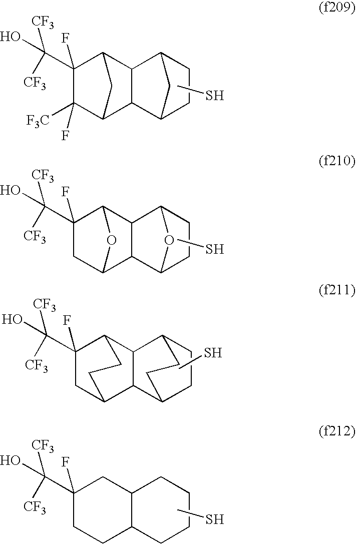

Of the thiol compounds represented by the formula (f), preferred for relatively easy production are, for example, thiol compounds having a norbornane ring or an oxa-norbornane ring, such as represented by (f101) to (f109); more preferred are thiol compounds having a norbornane ring, represented by (f101) to (f108); particularly preferred are thiol compounds represented by (f101) and (f102).

As to the method for synthesis of the thiol compound of the present invention, there is no particular restriction. The thiol compound can be synthesized, for example, by a method of adding hydrogen sulfide to an unsaturated hydrocarbon represented by the following formula (fp1); a method of adding thiosulfuric acid or a thiocarboxylic acid (e.g. thiopropionic acid) to an unsaturated hydrocarbon represented by the formula (fp1) and then conducting hydrolysis or alcoholysis; and a method of allowing thiourea to act on a chlorine atom- or bromine atom-containing compound represented by the following formula (fp2) and hydrolyzing the resulting thiuronium salt under an alkali condition. 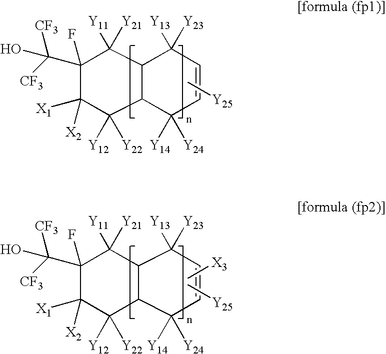
Incidentally, the substituent groups such as X₁ and the like in the formulas (fp1) and (fp2) are, except X₃ which is a halogen atom, the same as those in the formula (F).

In the copolymer for semiconductor lithography according to the present invention, as to the proportion of the terminal structure (F) to the total recurring units, a higher proportion gives higher lithography properties in development contrast, DOF, etc.; however, too high a proportion is not preferred because the resulting copolymer has too low a molecular weight, making difficult the formation of coating film. Therefore, the proportion can be selected in a range of ordinarily 0.1 to 20 mol %, preferably 0.5 to 10 mol %, particularly preferably 1 to 8 mol %.

In order for the proportion of the terminal structure represented by the formula (F) to fall in the above range, the thiol compound as a chain transfer agent is used in an amount of ordinarily 0.1 to 20 moles, preferably 0.5 to 10 moles, particularly preferably 1 to 8 moles relative to 100 mols of the raw material monomer. Incidentally, as the amount of the chain transfer agent used is larger, the proportion of the terminal structure in the copolymer is larger but the molecular weight of the copolymer obtained is smaller. Therefore, the amount of the chain transfer agent is selected so that the average molecular weight of the copolymer becomes a desired level.

The monomer giving at least the recurring unit (A) of the present copolymer for semiconductor lithography, having a structure wherein an alkali-soluble group has been protected with an acid-dissociating, dissolution-suppressing group, can be represented by the following formula (a):

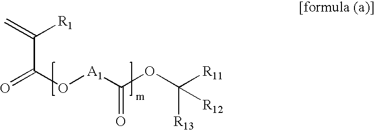

In the above formula, R₁ is a hydrogen atom or a hydrocarbon group of 1 to 4 carbon atoms; R₁₁ is a hydrocarbon group of 1 to 4 carbon atoms; R₁₂ and R₁₃ are each independently a straight chain or branched chain hydrocarbon group of 1 to 12 carbon atoms, or an alicyclic hydrocarbon group of single ring or bridge-containing ring, or, R₁₂ and R₁₃ bond to each other to form an alicyclic hydrocarbon group of single ring or bridge-containing ring, having 5 to 12 carbon atoms; or, R₁₁ and R₁₂ are each a hydrogen atom or a hydrocarbon group of 1 to 4 carbon atoms, and R₁₃ is an oxy group substituted with a straight chain or branched chain hydrocarbon group of 1 to 12 carbon atoms or with an alicyclic hydrocarbon group of single ring or bridge-containing ring; A₁ is an alicyclic hydrocarbon group having a bridge-containing ring of 7 to 12 hydrocarbons; and m is an integer of 0 or 1).

As specific examples of the compound of the formula (a), there can be mentioned (meth)acrylates shown by the following formulas. They can be used singly or in combination of two or more kinds.

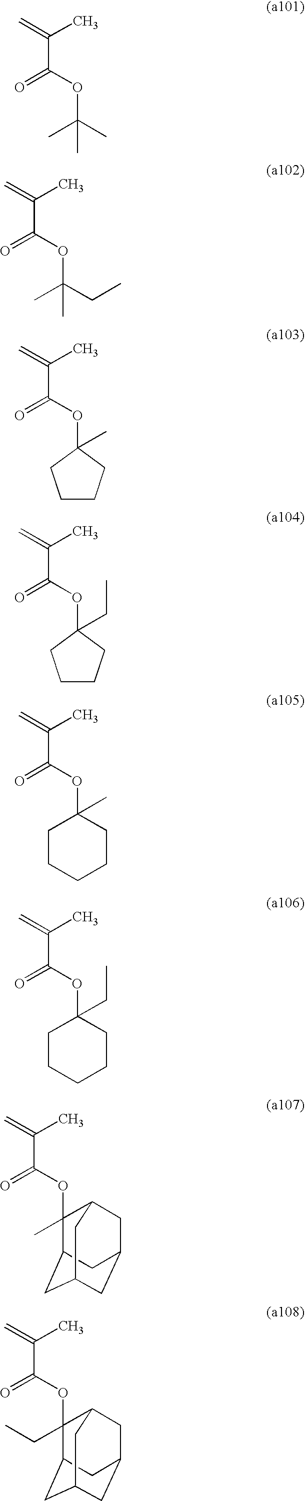

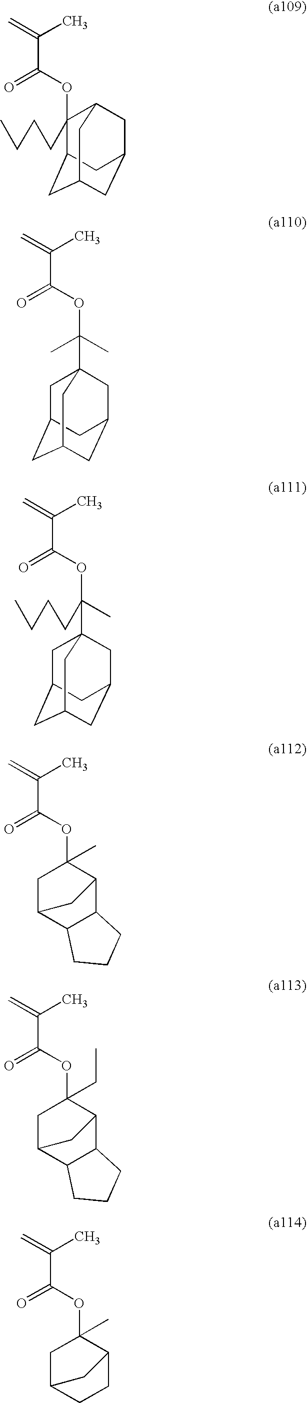

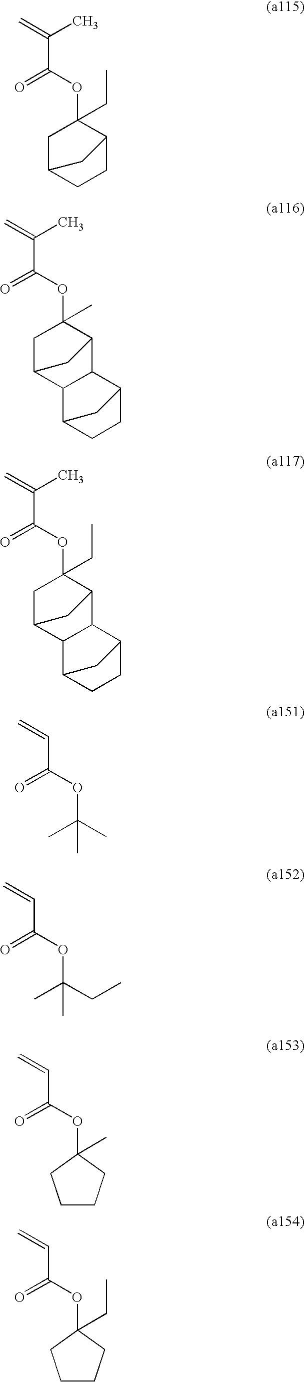

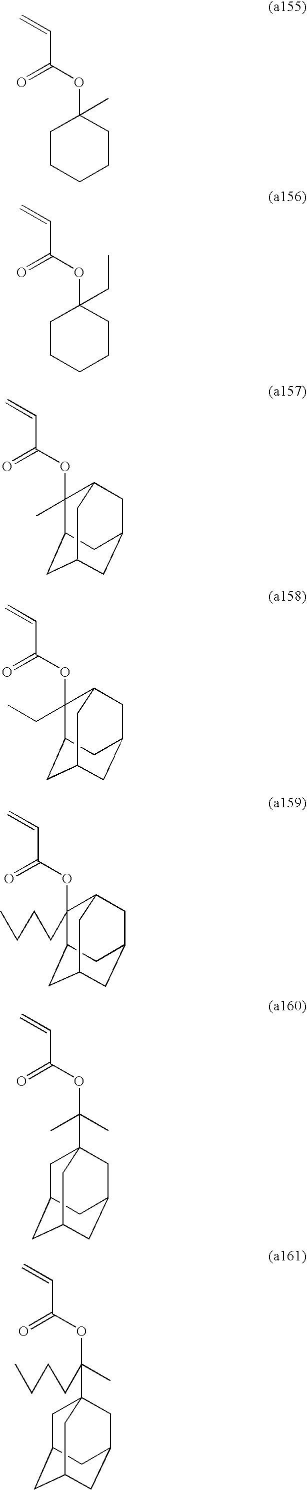

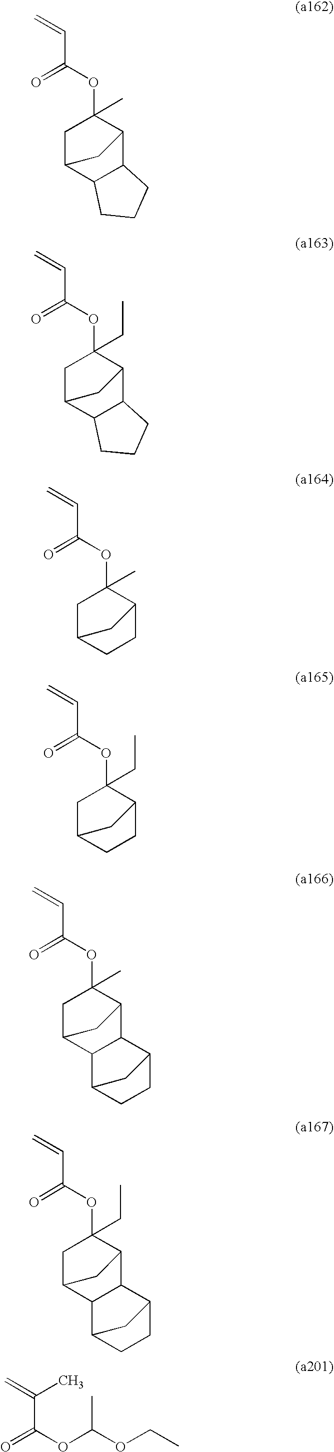

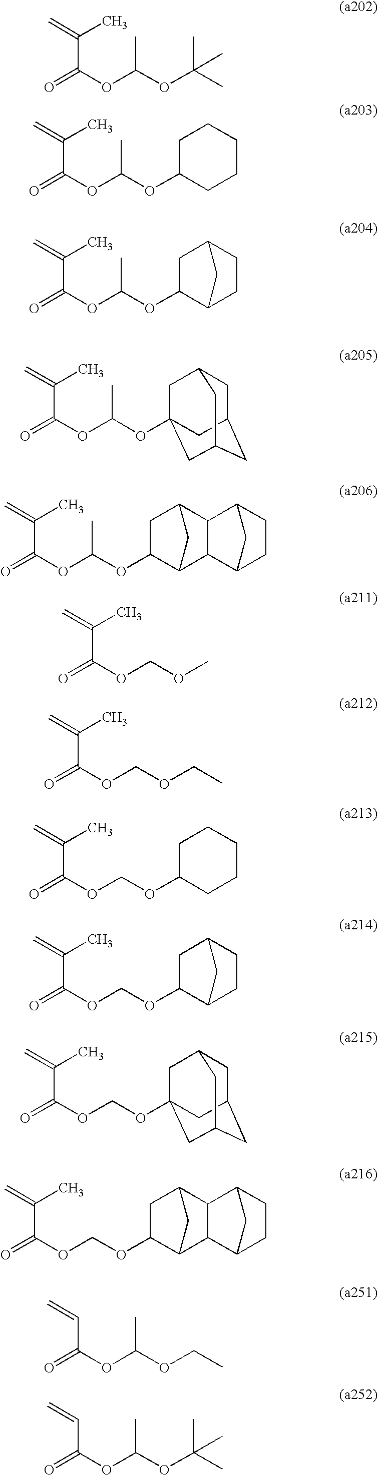

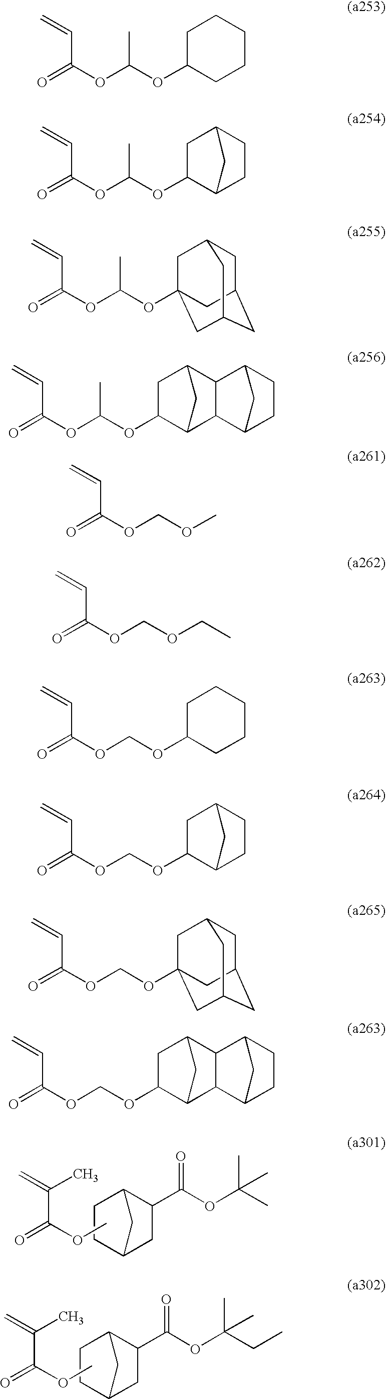

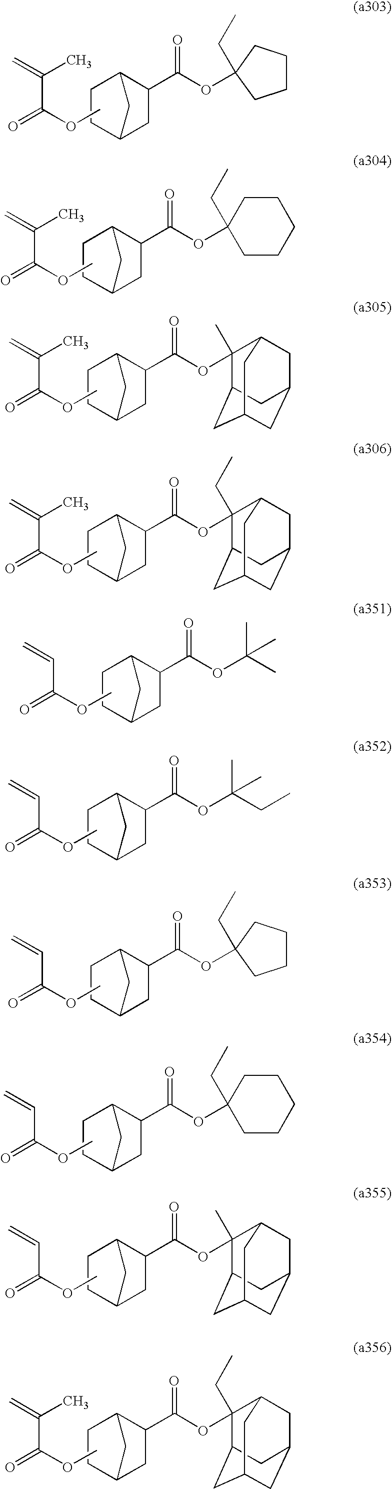

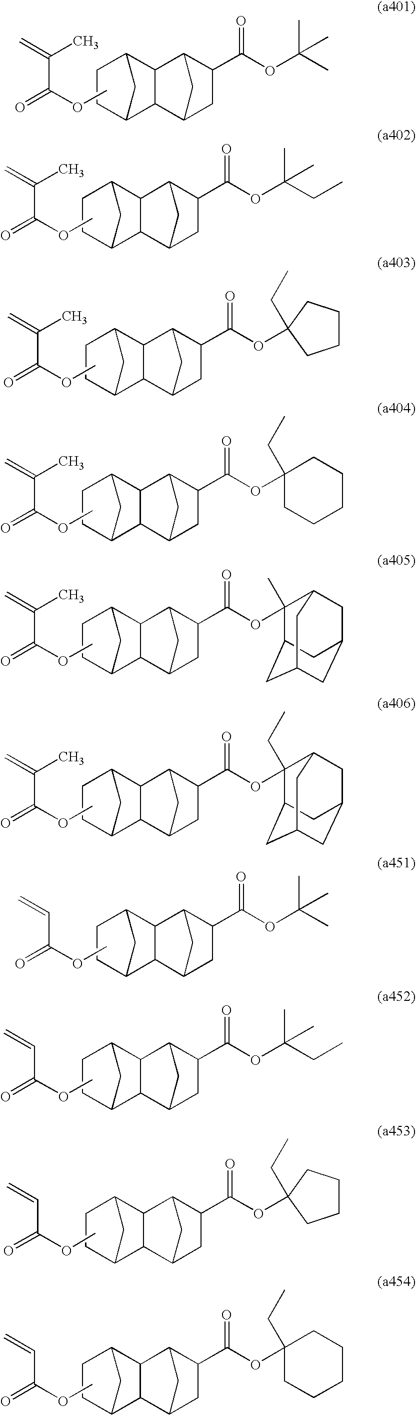

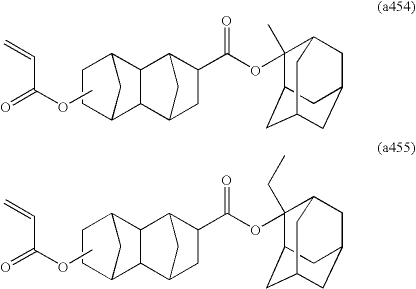

Preferably, the present copolymer for semiconductor lithography contains a recurring unit (C) having a lactone structure, represented by the following formula (C), in order to have higher adhesivity to semiconductor substrate or lower film and higher solubility in resist solvent:

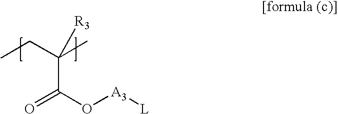

In the above formula, R₃ is a hydrogen atom or a hydrocarbon group having 1 to 4 carbon atoms; A₃ is a single bond, or an alicyclic hydrocarbon group having a single ring or a bridge-containing ring, having 5 to 12 carbon atoms; L is a lactone structure represented by the following general formula (L); A₃ and L bond to each other via one or two connecting groups: 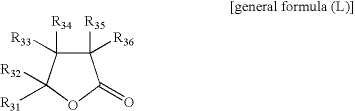
(wherein any one or two of R₃₁ to R₃₆ are connecting groups to A₃ of the general formula (C) and the remainder is each a hydrogen atom or a hydrocarbon or alkoxyl group having 1 to 4 carbon atoms).

The monomer giving the recurring unit (C) can be represented by the following formula (c): 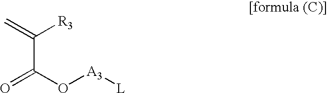
Incidentally, the substituent groups, etc. of the formula (c), such as R₃ and the like are the same as those in the formula (C).

As examples of the monomer represented by the formula (c), the (meth)acrylates shown by the following formulas can be mentioned. They can be used singly or in combination of two or more kinds.

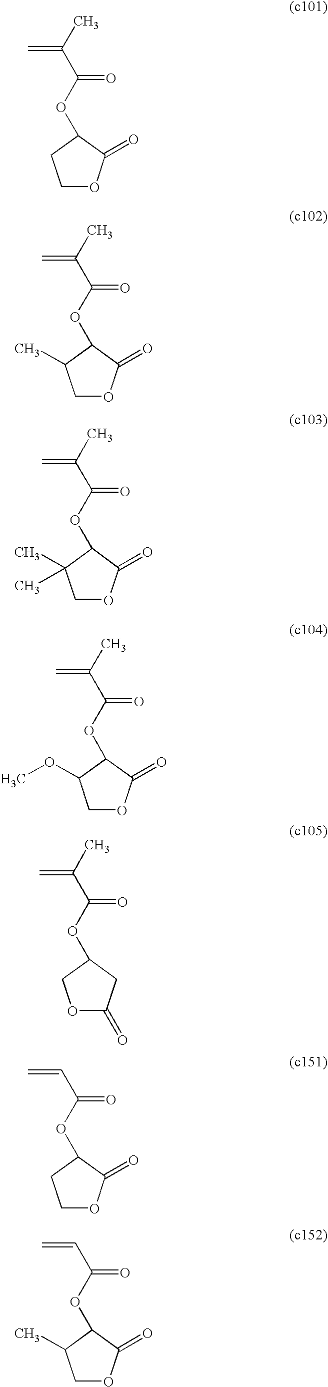

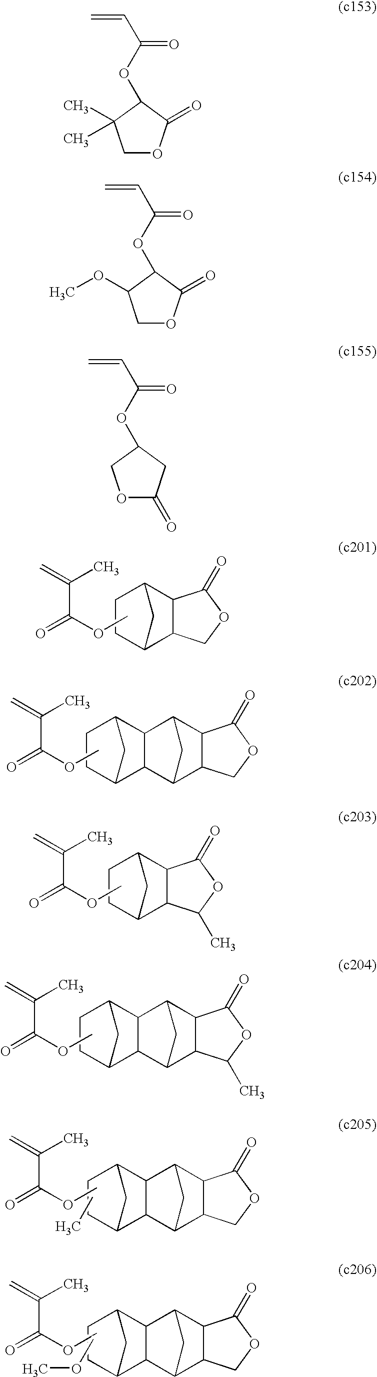

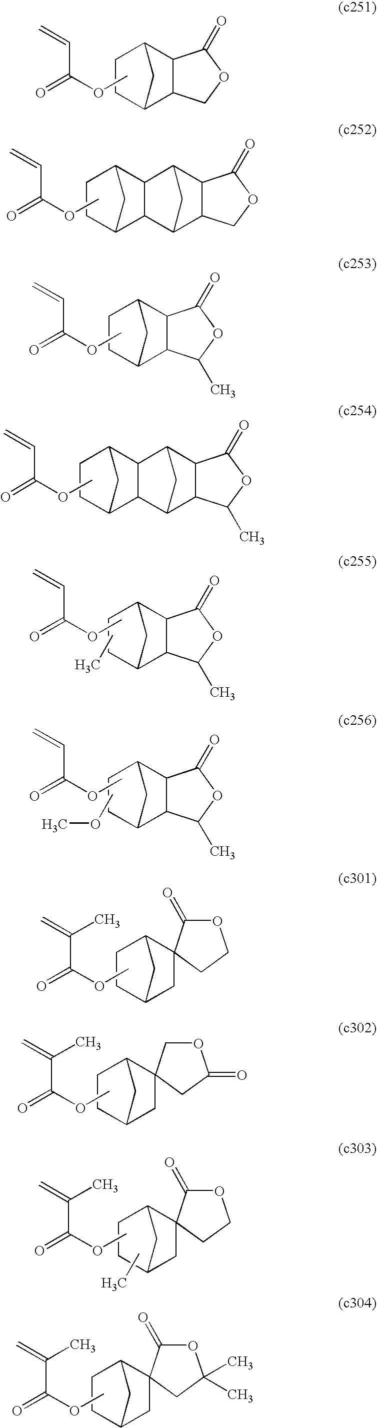

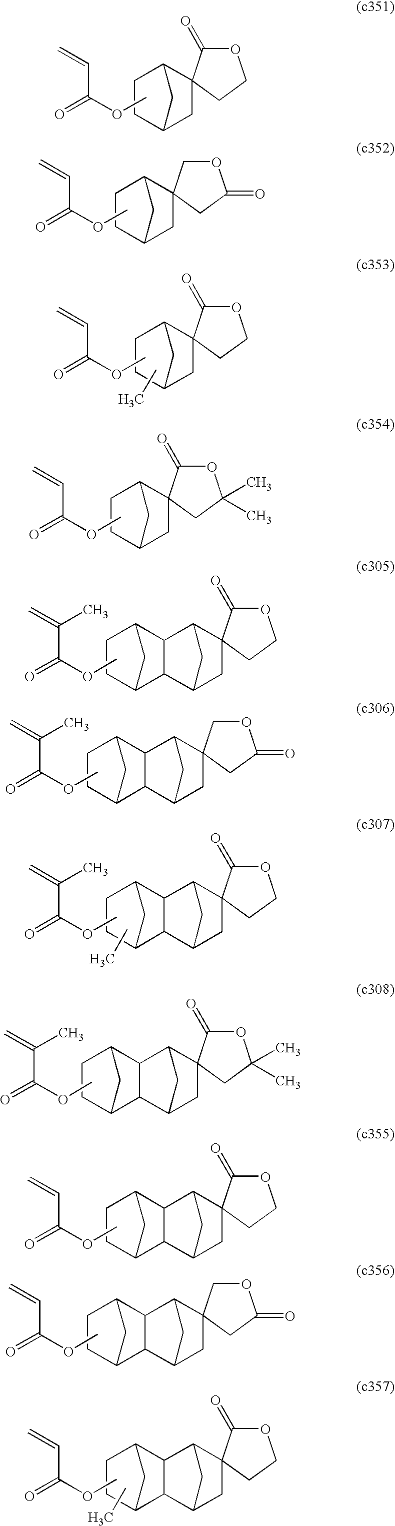

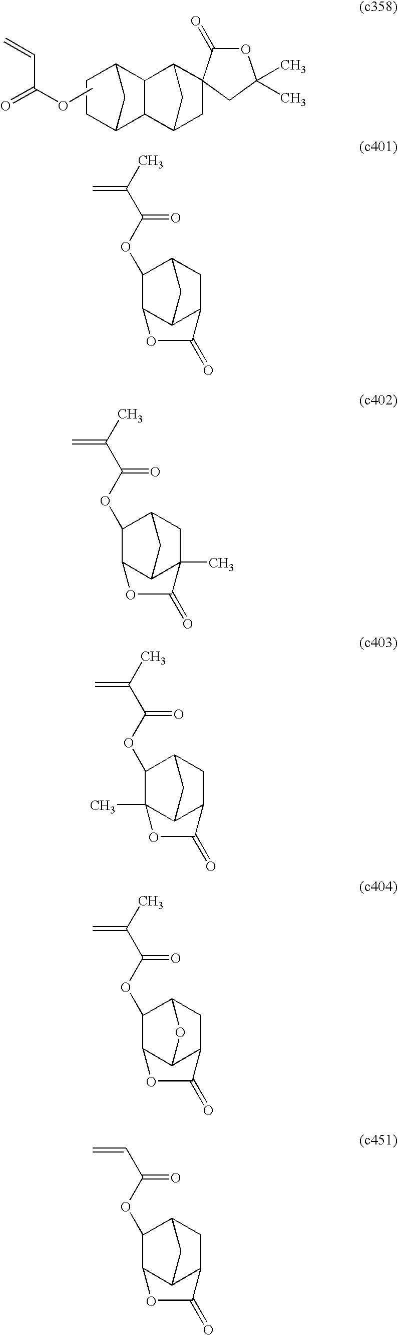

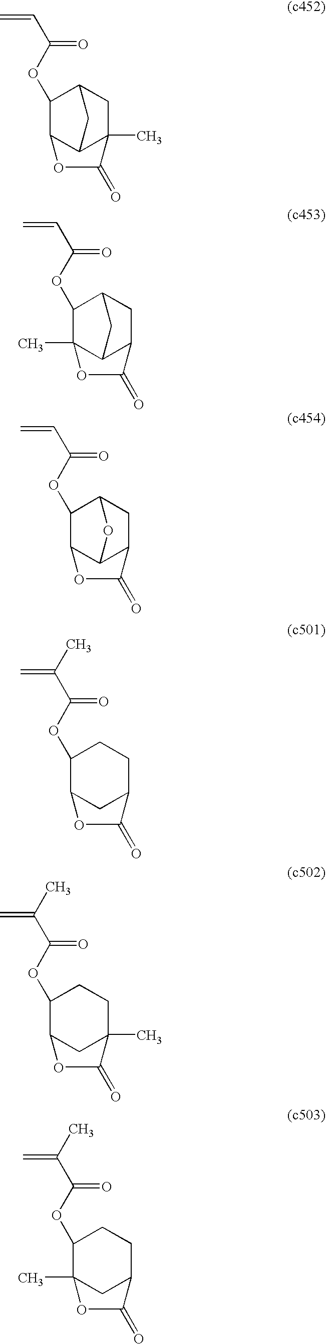

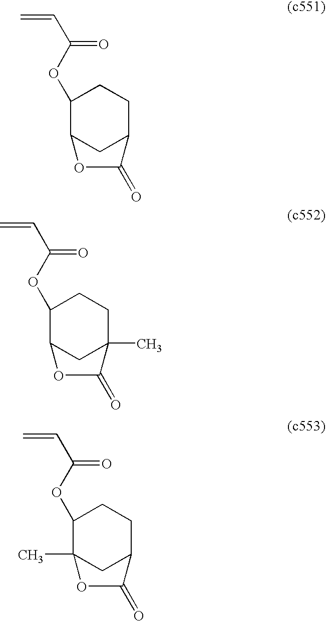

Further preferably, the copolymer of the present invention for semiconductor lithography contains a recurring unit (D) having an acid-stable, alicyclic hydrocarbon group, represented by the following general formula (D), in order to have controlled solubility in resist solvent or alkaline developing solution or have higher plasma etching resistance:

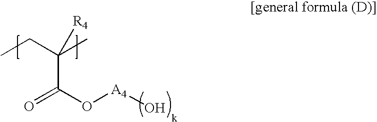

In the above formula, R₄ is a hydrogen atom or a hydrocarbon group having 1 to 4 carbon atoms; A₄ is an alicyclic hydrocarbon group having a bridge-containing ring of 7 to 12 carbon atoms, which may be substituted with halogen atom; and k is an integer of 0 to 3.

The monomer giving the recurring unit (D) can be represented by the following general formula (d): 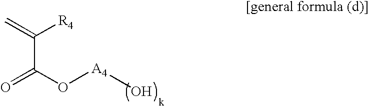
Incidentally, the substituent groups, etc. in the formula (d), such as R₄ and the like are the same as those in the formula (D).

As examples of the monomer represented by the formula (D), the (meth)acrylates shown by the following formulas can be mentioned. They can be used singly or in combination of two or more kinds.

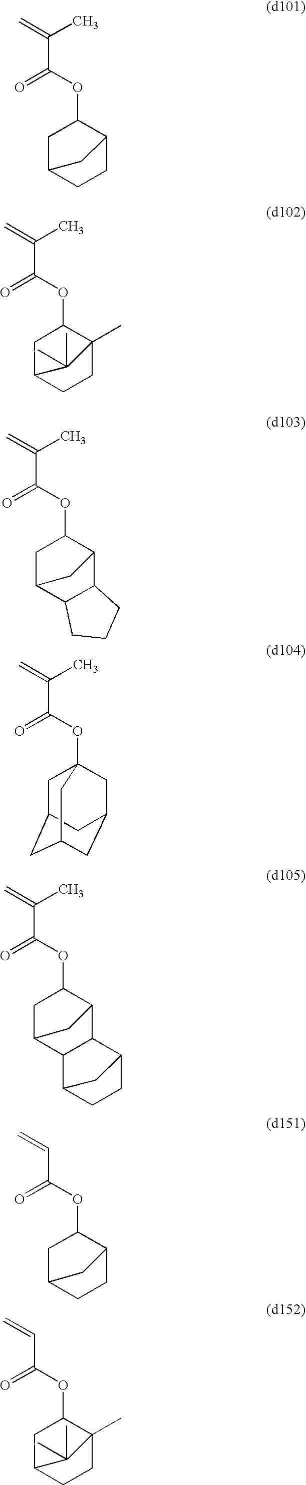

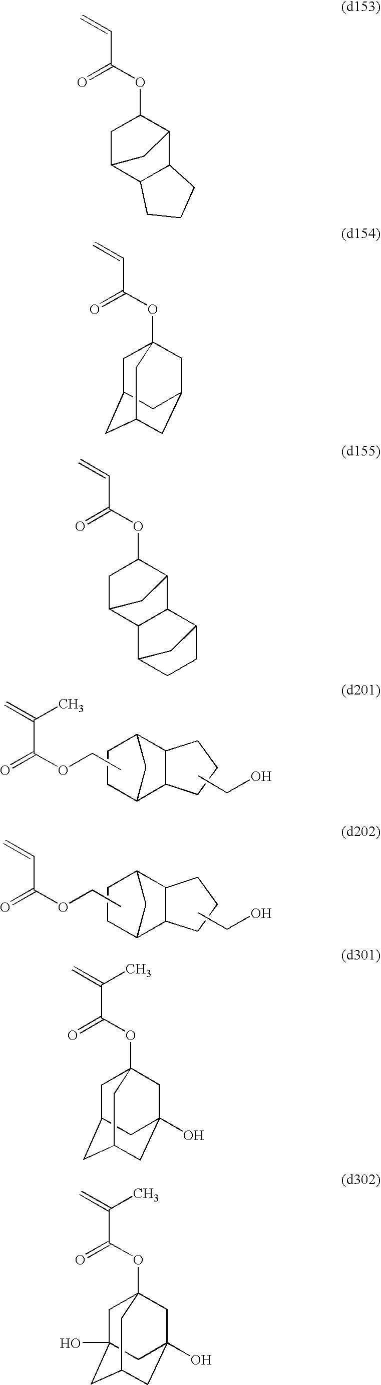

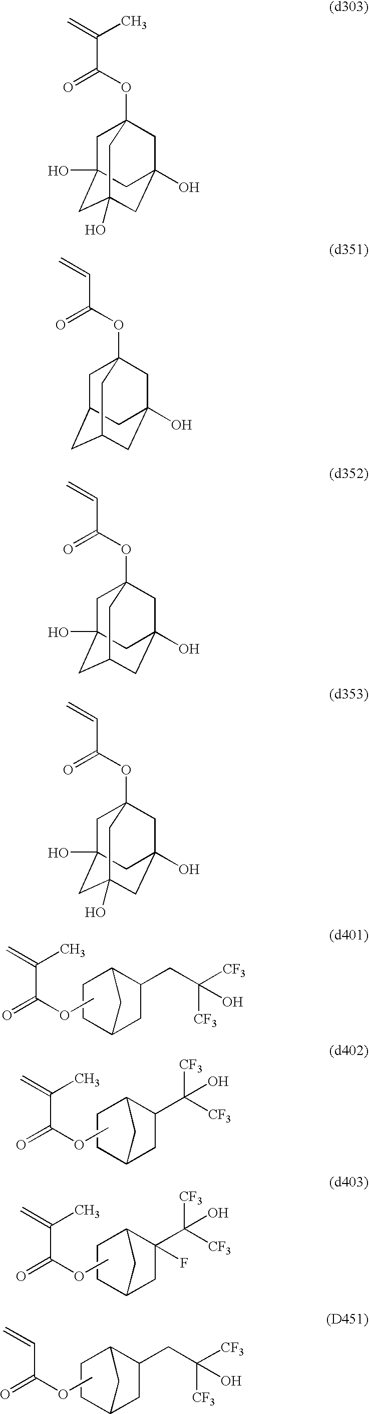

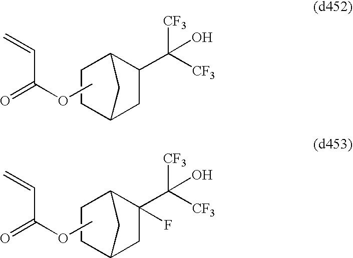

Of the monomers represented by the formula (d), preferred are hydroxyadamantyl (meth)acrylates of (d301) to (d303) and (d351) to (d353) because a good resist pattern shape is obtained easily therewith or the resist film formed therewith has high plasma etching resistance and particularly preferred are (d301) and (d351).

Further, the present copolymer for semiconductor lithography can contain a recurring unit (DS) having an acid-stable, aromatic hydrocarbon group, represented by the following formula (DS), in order to have, similarly to when the recurring units (C) and (D) are used, higher adhesivity to semiconductor substrate or lower film, higher solubility in resist solvent, higher plasma etching resistance, etc.: 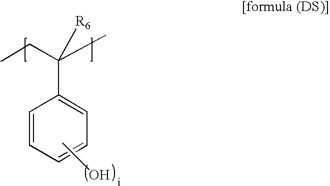
Incidentally, in the above formula, R₆ is a hydrogen atom or a hydrocarbon group of 1 to 4 carbon atoms, and i is an integer of 0 to 1.

The monomer giving the recurring unit (DS) can be represented by the following formula (ds): 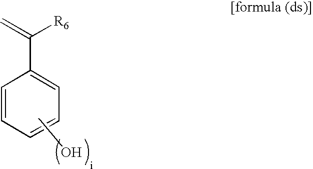
Incidentally, the substituent groups, etc. in the formula (ds), such as R₆ and the like are the same as those in the formula (DS).

As specific examples of the compound of the formula (ds), there can be mentioned styrenes such as styrene, p-hydroxystyrene, m-hydroxystyrene, p-hydroxy-α-methylstyrene, m-hydroxy-α-methylstyrene and the like. These compounds can be used singly or in combination of two or more kinds.

Besides, the present copolymer for semiconductor lithography can contain a recurring unit (E) represented by the following general formula (E): 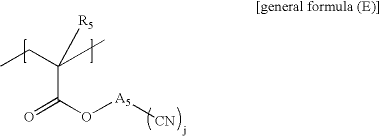
in order to control the solubility and the diffusion rate of acid in resist film. In the above formula, R₅ is a hydrogen atom or a hydrocarbon group having 1 to 4 carbon atoms; A₅ is an alicyclic hydrocarbon group having a bridge-containing ring of 7 to 12 carbon atoms, which may be substituted with halogen atom; and j is an integer of 1 to 2.

The monomer giving the recurring unit (E) can be represented by the following general formula (e): 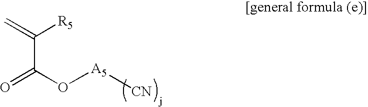
Incidentally, the substituent groups, etc. in the formula (e), such as R₅ and the like are the same as those in the formula (E).

As specific examples of the compound of the general formula (e), there can be mentioned (meth)acrylates shown by the following formula. They can be used singly or in combination of two or more kinds.

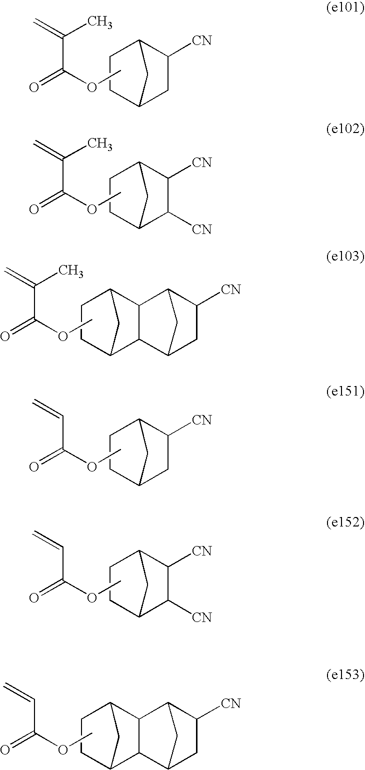

With respect to the above-mentioned monomers, at least one kind can be used for each of the recurring units (A), (C) and (D). The proportions of the recurring units (A), (C) and (D) can be each selected in a range in which the basic properties in semiconductor lithography are not impaired. That is, the recurring unit (A) can be selected in a range of 10 to 60 mol %, the recurring unit (C) can be selected in a range of 0 to 70 mol %, and the recurring unit (D) can be selected in a range of 0 to 40 mol %. Particularly preferably, the recurring unit (A) is 20 to 50 mol %, the recurring unit (C) is 20 to 60 mol %, and the recurring unit (D) is 5 to 35 mol %.

The recurring unit (DS) shows a relatively high transmittance for 248 nm wavelength and a relatively low transmittance for 193 nm wavelength. Accordingly, the proportion of the recurring unit (DS) can be selected in a range of ordinarily 0 to 80 mol %, preferably 0 to 70 mol %, particularly preferably 0 to 60 mol % when the wavelength of the radiation used in lithography is 248 nm. When the wavelength of the radiation used in lithography is 193 nm, the proportion of the recurring unit (DS) can be selected in a range of ordinarily 0 to 30 mol %, preferably 0 to 20 mol %, particularly preferably 0 to 10 mol %.

As to the weight-average molecular weight (Mw) of the present copolymer for semiconductor lithography, when it is too high, the solubility of copolymer in resist solvent or alkaline developing solution is low. Meanwhile, when it is too low, the properties of resist film are inferior. Therefore, the weight-average molecular weight (Mw) of the copolymer is preferably in a range of 2,000 to 40,000, more preferably in a range of 3,000 to 30,000, particularly preferably in a range of 4,000 to 25,000. The molecular weight distribution (Mw/Mn) of the copolymer is preferably in a range of 1.0 to 5.0, more preferably in a range of 1.0 to 3.0, particularly preferably in a range of 1.2 to 2.5.

The step (P) for polymerizing at least the monomer giving the recurring unit (A) can be conducted by radical polymerization in an organic solvent. The method thereof can be selected from publicly known methods with no restriction. Such methods include, for example, (1) a simultaneous polymerization method wherein a monomer(s) and a polymerization initiator are dissolved in the same solvent and the solution is heated to give rise to polymerization, (2) a dropping polymerization method wherein a monomer(s) and a polymerization initiator are dissolved in the same solvent as necessary and then dropped together into a heated solvent to give rise to polymerization, (3) an independent dropping polymerization method wherein a monomer(s) and a polymerization initiator are independently dissolved in a solvent as necessary and then dropped independently into a heated solvent to give rise to polymerization, and (4) an initiator-dropping polymerization method wherein a monomer (s) is (are) dissolved in a solvent and heated and a polymerization initiator separately dissolved in a solvent is dropped into the heated monomer(s) solution to give rise to polymerization. Here, in the polymerization system in the cases of the methods (1) and (4) and in the to-be-dropped solution tank in the case of the method (2), an unreacted monomer(s) of high concentration contacts (contact) with a radical of low concentration; therefore, there is easy formation of a high polymer having a molecular weight of 100,000 or more which is one cause of defect generation. In contrast, in the case of the independent dropping polymerization method (3), there is no formation of a high polymer because the monomer(s) does (do) not co-exist with the polymerization initiator in the to-be-dropped solution tank and, even when the monomer(s) is (are) dropped into the polymerization system, the unreacted monomer(s) is (are) at a low concentration(s) and accordingly there is no formation of a high polymer. Thus, the independent dropping polymerization method (3) is particularly preferred as the polymerization method of the present invention. Incidentally, in the dropping polymerization methods (2) and (3), the composition of monomers dropped, the proportions of monomers, polymerization initiator and chain transfer agent, etc. may be changed with the lapse of dropping time.

As to the polymerization initiator, there is no particular restriction as long as it is one generally used as a radical-generating agent. There can be used, for example, azo compounds such as 2,2′-azobisisobutyronitrile, 2,2′-azobis(2-methylbutyronitrile), dimethyl 2,2′-azobisisobutyrate, 1,1′-azobis(cyclohexane-1-carbonitrile), 4,4′-azobis(4-cyanovaleric acid) and the like; and organic peroxides such as decanoyl peroxide, lauroyl peroxide, benzoyl peroxide, bis(3,5,5-trimethylhexanoyl) peroxide, succinic acid peroxide, tert-butyl peroxy-2-ethylhexanoate, tert-butyl peroxypivalate, 1,1,3,3-tetramethylbutyl peroxy-2-ethylhexanoate and the like. These compounds can be used singly or in admixture. The amount of the polymerization initiator used can be determined depending upon various conditions such as intended Mw, the kinds and the composition of copolymer, polymerization initiator, chain transfer agent and solvent, polymerization temperature, dropping rate and the like.

In the present invention, use of the thiol compound represented by the formula (f) as a chain transfer agent is essential. There may be used, together with the thiol compound of the formula (f), publicly known thiol compounds singly or in admixture. Such thiol compounds include dodecanethiol, mercaptoethanol, mercaptopropanol, mercaptoacetic acid, mercaptopropionic acid and thiol compounds of the following formula (t1) or (t2) wherein a saturated hydrocarbon gas been substituted with 2-hydroxy-1,1,1,3,3,3-hexafluoro-2-propylidene group and mercapto group: 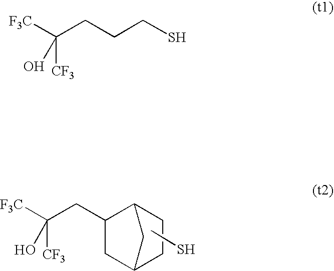
The effect of the compound of the formula (f) is low when the proportion of the publicly known chain transfer agent(s) to the compound of the formula (f) is high; therefore, the use amount of the publicly known chain transfer agent(s) is preferably as small as possible, and use of only the compound of the formula (f) is particularly preferable.

In the simultaneous polymerization method (1), the chain transfer agent can be dissolved in the same solvent together with the monomer(s) and the polymerization initiator and then heated. In the dropping polymerization methods (2) to (4), the chain transfer agent may be dropped by mixing with the monomer(s) or with the polymerization initiator, or may be dissolved beforehand in the solvent to be heated.

The amount of the chain transfer agent used can be determined depending upon various conditions such as intended Mw, the kinds and the composition of copolymer, polymerization initiator, chain transfer agent and solvent, polymerization temperature, dropping rate and the like.

As to the solvent, there is no particular restriction as long as it is a compound publicly known as a solvent and can dissolve the monomer(s), polymerization initiator and chain transfer agent used and further the copolymer obtained by polymerization. As examples of such a solvent, there can be mentioned ketones such as acetone, methyl ethyl ketone, methyl iso-amyl ketone, methyl amyl ketone, cyclohexanone and the like; esters such as methyl acetate, ethyl acetate, butyl acetate, methyl propionate, methyl 3-methoxypropionate, ethyl 3-ethoxypropionate, methyl lactate, ethyl lactate, γ-butyrolactone and the like; ethers such as tetrahydrofuran, dioxane, ethylene glycol dimethyl ether, diethylene glycol dimethyl ether and the like; ether alcohols such as ethylene glycol monomethyl ether, ethylene glycol monoethyl ether, ethylene glycol monobutyl ether, propylene glycol monomethyl ether, 3-methoxy-3-methyl-1-butanol and the like; ether esters which are ester compounds between the above-mentioned ether alcohol and acetic acid or the like; aromatic hydrocarbons such as toluene, xylene and the like; amides such as N,N-dimethylformamide, N-methylpyrrolidone and the like; dimethyl sulfoxide; and acetonitrile. They can be used singly or in admixture of two or more kinds.

The polymerization temperature can be appropriately determined depending upon, for example, the boiling points of solvent, monomer(s), chain transfer agent, etc, and the half-life temperature of polymerization initiator. With a low polymerization temperature, polymerization is unlikely to proceed, posing a problem in productivity; with an unnecessarily high polymerization temperature, there is a problem in the stabilities of monomer(s) and resist polymer. Accordingly, the polymerization temperature is selected in a range of preferably 40 to 120° C., particularly preferably 60 to 100° C.

As to the dropping time in the dropping polymerization method, a short time is not preferred because the molecular weight distribution of the polymer obtained tends to be wide and the dropping of a large amount of solution at one time gives rise to temperature fall of polymerization mixture; and a long time is not preferred because the copolymer formed undergoes a more-than-required thermal history, which lowers productivity. Accordingly, the dropping time is selected in a range of ordinarily 30 minutes to 24 hours, preferably 1 to 12 hours, particularly preferably 2 to 8 hours. After the dropping in the dropping polymerization method or after the arrival at the polymerization temperature in the simultaneous polymerization method, it is preferred that the system temperature is kept at a given temperature or is increased to conduct aging, to react remaining unreacted monomer(s). As to the time of aging, too long a time is not preferred because the production efficiency per hour is low and the copolymer formed undergoes a more-than-required thermal history. Accordingly, the aging time is selected in a range of ordinarily 12 hours or less, preferably 6 hours or less, particularly preferably 1 to 4 hours.

The copolymer obtained via the step (P) contains unrequired substances such as unreacted monomer(s), low-molecular components (e.g. oligomer), polymerization initiator and chain transfer agent and reaction residues thereof, and the like; therefore, the copolymer is preferably purified using a solvent to remove such unrequired substances [this step is hereinafter referred to as step (R)]. As the method for the step (R), there can be mentioned, for example, a method (R-1) wherein a poor solvent is added to precipitate a copolymer, then the solvent phase is separated; a method (R-1a) wherein, following the method (R-1), a poor solvent is added to wash the copolymer and then the solvent phase is separated; a method (R-1b) wherein, following the method (R-1), a good solvent is added to re-dissolve the copolymer, a poor solvent is added to re-precipitate a copolymer and then the solvent phase is separated; a method (R-2) wherein a poor solvent is added to form two phases, i.e. a poor solvent phase and a good solvent phase and then the poor solvent phase is separated; and a method (R-2a) wherein, following the method (R-2), a poor solvent is added to wash the good solvent phase and then the poor solvent phase is separated. The methods (R-1a), (R-1b) and (R-2a) may each be repeated, or may be combined.

The poor solvent is not particularly restricted as long as the copolymer is sparingly soluble therein; and there can be used, for example, water, alcohols (e.g. methanol and isopropanol), and saturated hydrocarbons (e.g. hexane and heptane). The good solvent is not particularly restricted as long as the copolymer dissolves easily therein, and can be used as a single solvent or a mixed solvent. The good solvent is preferably the same solvent as the polymerization solvent, for control of the process for copolymer production. As examples of the good solvent, there can be mentioned the same solvents as specifically mentioned as the reaction solvent of the step (P).

The copolymer after purification contains the solvent used in the purification and, therefore, is subjected to drying under reduced pressure and thereby is finished into a dried, solid copolymer of reduced solvent content. Or, the copolymer before or after drying is dissolved in a solvent specifically mentioned as the reaction solvent of the step (P), or in an organic solvent which constitutes a resist composition described later (the organic solvent is hereinafter referred to as resist solvent), and then the resulting solution is subjected to distillation while the resist solvent is fed as necessary, to remove low-boiling compounds other than the resist solvent, to obtain a solution of a copolymer dissolved in the resist solvent.

The temperature of the reduced-pressure drying or the solvent substitution is not particularly restricted unless the copolymer undergoes property change, and is ordinarily 100° C. or less, preferably 80° C. or less, particularly preferably 70° C. or less. As to the amount of the resist solvent used for the solvent substitution, too small an amount is not preferred because the removal of low-boiling compounds is not sufficient, and too large an amount is not preferred because a long time is taken for the solvent substitution and the copolymer formed undergoes a more-than-required thermal history. The amount of the resist solvent used is ordinarily 1.05 to 10 times, preferably 1.1 to 5 times, particularly preferably 1.2 to 3 times the solvent amount in the copolymer solution obtained.

The dried, solid copolymer is dissolved in one kind of resist solvent or in two or more kinds of resist solvents. The solution of the copolymer dissolved in the resist solvent is diluted as necessary with the resist solvent or mixed with other kind of resist solvent. To the resulting copolymer solution are added a radiation-sensitive, acid-generating agent (X) [hereinafter referred to as component (X)], an acid diffusion-suppressing agent [hereinafter referred to as component (Y)] (e.g. a nitrogen-containing organic compound) for prevention of acid diffusion into the area not exposed to radiation and, as necessary, other additive (Z) [hereinafter referred to as component (Z)], whereby a resist composition is obtained finally.

The component (X) can be appropriately selected from those compounds heretofore proposed as the radiation-sensitive, acid-generating agent for chemical amplification type resist. As examples thereof, there can be mentioned onium salts such as iodonium salt, sulfonium salt and the like; oxime sulfonates; diazomethanes such as bisalkyl- or bisarylsulfonyldiazomethane and the like; nitrobenzylsulfonates; iminosulfonates; and disulfones. Of these, an onium salt using a fluorinated alkylsulfonic acid ion as the anion is particularly preferred. They can be used singly or in combination of two or more kinds. The component (X) is used in an amount of ordinarily 0.5 to 30 parts by mass, preferably 1 to 10 parts by mass relative to 100 parts by mass of the copolymer.

The component (Y) can be appropriately selected from those compounds heretofore proposed as the acid diffusion-suppressing agent for chemical amplification type resist. As examples thereof, there can be mentioned nitrogen-containing organic compounds, and primary to tertiary alkylamines and hydroxyalkylamines are preferred. Tertiary alkylamines and tertiary hydroxyalkylamines are preferred particularly. Of them, triethanolamine and triisopropanolamine are most preferred. They can be used singly or in combination of two or more kinds. The component (Y) is used in an amount of ordinarily 0.01 to 5.0 parts by mass relative to 100 parts by mass of the copolymer.

The resist solvent may be any solvent as long as it can dissolve each component constituting the resist composition and form a homogeneous solution. It can be selected freely from the solvents each heretofore known publicly as a solvent for chemical amplification type resist, and can be used as a single solvent or a mixed solvent of two or more kinds. Ordinarily, it can be selected from the solvents specifically mentioned as the reaction solvent of the step (P) or as the good solvent of the step (R), in view of the solvency for the composition excluding the copolymer, the viscosity, the boiling point, the absorption of the radiation used in lithography, etc. Preferred resist solvents are methyl amyl ketone, cyclohexanone, ethyl lactate (EL), γ-butyrolactone and propylene glycol monomethyl ether acetate (PGMEA). A mixed solvent of PGMEA and other polar solvent is preferred particularly. As the polar solvent used in the mixed solvent, EL is preferred particularly.

The amount of the resist solvent contained in the resist composition is not particularly restricted. Ordinarily, it is appropriately determined so that the resulting composition has a concentration allowing for coating on substrate or the like and has a viscosity appropriate for the intended thickness of coating film. In general, the resist solvent is used so that the solid content in the resist composition becomes 2 to 20% by mass, preferably 5 to 15% by mass.

As the additive (Z), there can be appropriately and as necessary added compounds conventionally used as additives for resist, such as organic carboxylic acid and phosphorus-containing oxo-acid for prevention of sensitivity deterioration of acid-generating agent or for improvement of shape and stability of resist pattern, additional resin for improvement of resist film properties, surfactant for improvement of coatability, dissolution-suppressing agent, plasticizer, stabilizer, coloring agent, halation-preventing agent, dye and the like. As examples of the organic carboxylic acid, there can be mentioned malonic acid, citric acid, malic acid, succinic acid, benzoic acid, salicylic acid, etc., and they can be used singly or in admixture of two or more kinds. The organic carboxylic acid is used in an amount of 0.01 to 5.0 parts by mass relative to 100 parts by mass of the copolymer.

By using the copolymer for semiconductor lithography according to the present invention, there can be obtained a resist composition superior in lithography properties such as development contrast, DOF and the like. The reason thereof is not certain but can be considered to be as follows. That is, since the terminal structure of copolymer, represented by the formula (F) is a substituent group having an appropriate acid dissociation constant not possessed by generally known structures, the solubility of copolymer in developing solution is controlled at the most appropriate level; since there is no basicity such as possessed by amino group or carbamoyl group, diffusion of acid is appropriate; these matters are presumed to yield the above-mentioned superior resist composition.

### EXAMPLES

The present invention is described in more detail below by way of Examples. However, the present invention is in no way restricted to these Examples. Incidentally, the abbreviations used the following Examples have the following meanings.

Monomer G: γ-butyrolacton-2-yl methacrylate [(c101) in the Detailed Description portion]

Monomer Ga: γ-butyrolacton-2-yl acrylate [(c151) in the Detailed Description portion]

Monomer M: 2-methyl-2-adamantyl methacrylate [(a107) in the Detailed Description portion]

Monomer O: 3-hydroxy-1-adamantyl methacrylate [(d301) in the Detailed Description portion]

Monomer Oa: 3-hydroxy-1-adamantyl acrylate [(d351) in the Detailed Description portion]

Chain transfer agent V: 1,1,1,3,3,3-hexafluoro-2-(5 or 6-mercapto-bicyclo[2.2.1]hepto-2-fluor-2-yl)propane-2-ol [(f101) in the Detailed Description portion]

Chain transfer agent N: 1,1,1,3,3,3-hexafluoro-2-(5 or 6-mercapto-bicyclo[2.2.1]hept-2-ylmethyl)propane-2-ol [(t2) in the Detailed Description portion]

Polymerization initiator I: dimethyl 2,2′-azobisisobutylate

G: a recurring unit derived from monomer G

Ga: a recurring unit derived from monomer Ga

M: a recurring unit derived from monomer M

O: a recurring unit derived from monomer O

Oa: a recurring unit derived from monomer Oa

V: a terminal structure derived from chain transfer agent V

N: a terminal structure derived from chain transfer agent N

I: a terminal structure derived from polymerization initiator I

The structures of G to I are shown below.

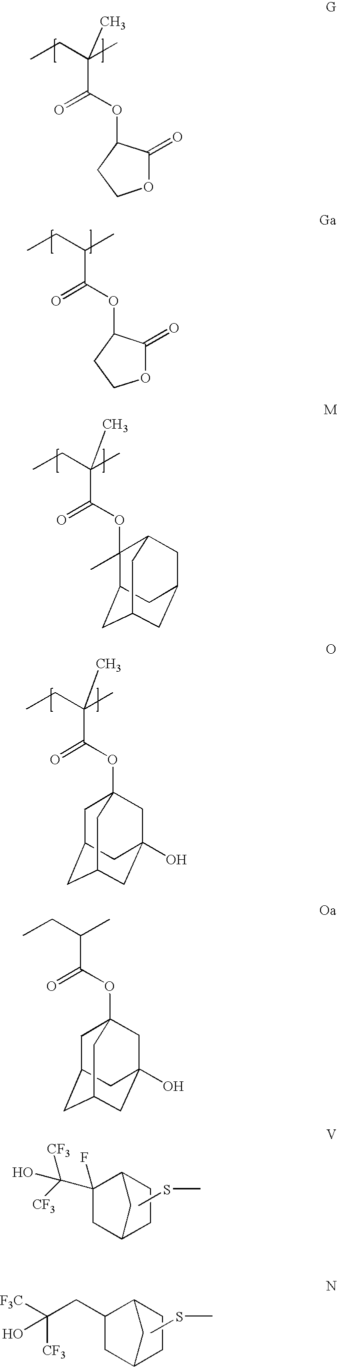

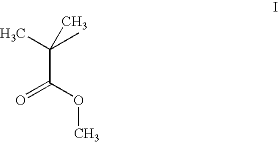

There were measured, according to the following methods, the Mw, Mw/Mn, proportions of recurring units and proportion(s) of terminal structure(s), of copolymer, development contrast (tan θ), the width of depth of focus (DOF), optimum exposure amount (Eop) and Expsure Latitude margin (EL).

(1) Measurement of Mw and Mw/Mn of Copolymer by GPC

Measured according to GPC. The analytical conditions were as follows.

Apparatus: GPC 8220 produced by Tosoh Corporation

Detector: a differential refractive index (RI) detector

Columns: KF-804L (three columns) produced by Showa Denko K.K.

Sample: a sample for measurement was prepared by dissolving about 0.1 g of a powdery copolymer in about 1 ml of tetrahydrofuran. The amount of the sample injected into the GPC was 15 μl.

(2) Measurement of Proportions of Recurring Units and Proportion(s) of Terminal Structure(s) of Copolymer by ¹³C-NMR

Apparatus: AV 400 produced by Bruker

Sample: a sample for measurement was prepared by dissolving about 1 g of a powdery copolymer and 0.1 g of Cr(acac)₂ in 1 g of MEK and 1 g of deutrated acetone.

Measurement: a glass-made tube of 10 mm in inner Diameter was used; temperature: 40° C.; scanning: 10,000 times

(3) Measurement of tan θ

A resist composition was spin-coated on a 4-inch silicon wafer, followed by prebaking (PAB) on a hot plate at 100° C. for 90 seconds, to form a resist film of 350 nm in thickness. Using an ArF excimer laser exposure system (VUVES-4500 produced by Lithotec Japan), 18 square areas (10 mm×10 mm) were exposed at various exposure amounts. Then, post baking (PEB) was conducted at 120° C. for 90 seconds; using a resist development analyzer (RDA-800 produced by Litho Tech Japan), the resist film after post baking was subjected to development at 23° C. with a 2.38 mass % aqueous tetramethylammonium hydroxide solution; and the change with time, of the thickness of resist film during development was measured for each exposure amount.

Base on the data obtained, a discrimination curve (a rate of dissolution in alkali at each exposure amount) was prepared. From the angle of rise of the curve, tan θ was determined.

(4) Simulation of DOF, Eop and EL

Based on the data obtained in the above (3), exposure was conducted at wavelength=193 nm, NA=0.68 and ⅔ annular illumination using a development simulation soft (Prolith V9 produced by KLA Tencor), and there were determined width of depth of focus (DOF), optimum exposure amount (Eop) and Expsure Latitude margin (EL) when a 130 nm line and space pattern was formed.

### Example 1

### Synthesis of Chain Transfer Agent V [(f101) Mentioned Above]

12.04 g (158 mol) of thioacetic acid was placed in a three-necked, round-bottom flask fitted with a stirrer, a thermometer, a condenser and a dropping funnel, and the flask inside was heated to 80° C. When the flask inside temperature reached 80° C., there was dropped, from the dropping funnel in 2 hours, a mixture of 0.331 g (1.44 mmol) of dimethyl 2,2′-azobisisobutyrate and 40 g (144 mmol) of 2-(bicyclo[2.2.1]hept-5-ene-2-fluor-2-yl)-1,1,1,3,3,3-hexafluoropropane-2-ol, and stirring was conducted at 80° C. for 2 hours. Then, to the reaction mixture were added 9 g of methanol and 4.10 g (21.6 mmol) of p-toluenesulfonic acid mono-hydrate, and stirring was conducted for 2 hours under refluxing. Thereafter, the reaction mixture was returned to room temperature and washed with a 7% aqueous sodium hydrogencarbonate solution twice and with water twice. The resulting organic layer was subjected to distillation under reduced pressure to remove the low-boiling substances to obtain 29.1 g of a solid. The solid was analyzed by GC-MS, ¹H-NMR and ¹³C-NMR, whereby the solid was confirmed to be a mixture of at least 5 kinds of isomers all of the following general formula (f101) The purity of the total of 5 kinds by GC-FID was 98% by area.

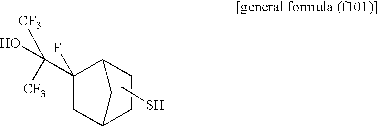

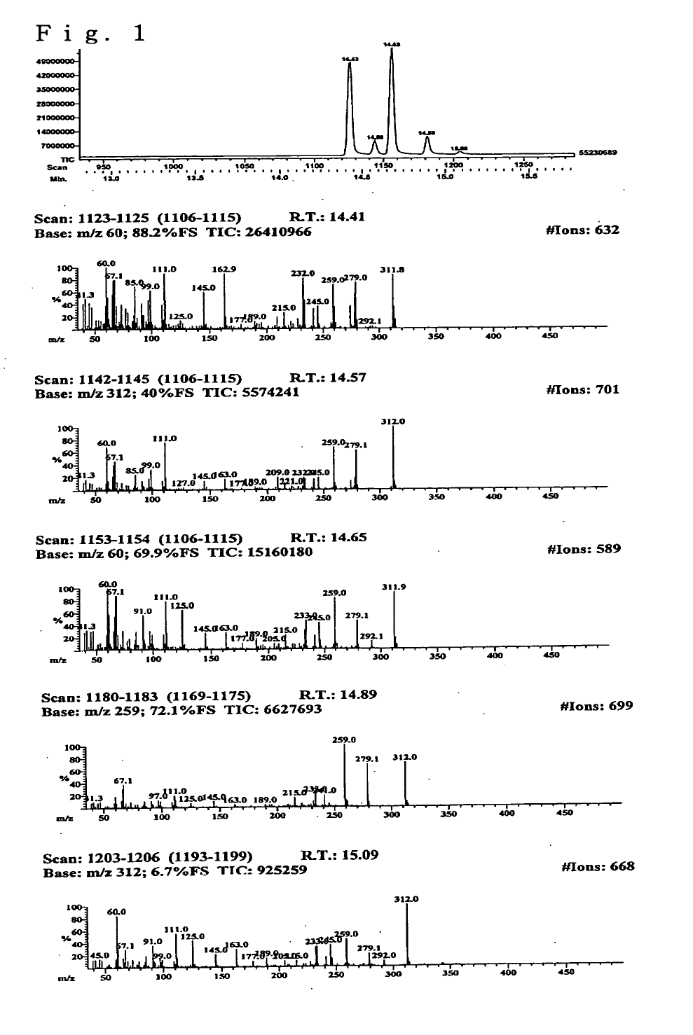

Mass spectrum (GC-MS) m/z: 312 (M+): shown in FIG. 1.

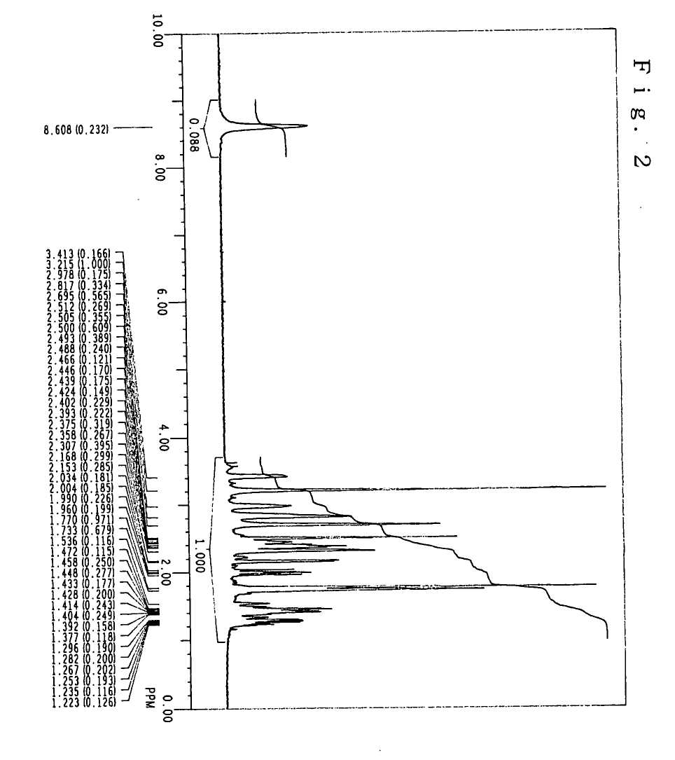

¹H-NMR (solvent: DMSO-d₆): shown in FIG. 2.

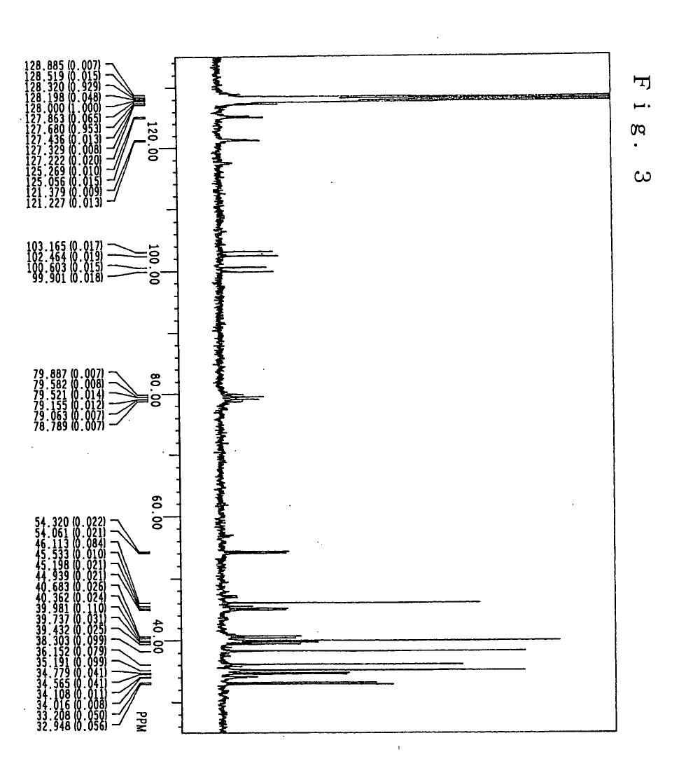

¹³C-NMR (solvent: C₆D6): Shown in FIG. 3.

### Example 2

In a container purged with nitrogen were placed 98.8 g of methyl ethyl ketone (MEK), 37.44 g of monomer M (A), 26.52 g of monomer G (C), 18.65 g of monomer Oa (D), 4.12 g of chain transfer agent V (F) and 0.28 g of polymerization initiator I. They were made into a solution to prepare a homogeneous “feed solution”. 62 g of MEK was placed in a reactor fitted with a stirrer and a cooler. The reactor inside was purged with nitrogen and heated to 80° C. The feed solution kept at room temperature (about 25° C.) was dropped into the reactor kept at 79 to 81° C., using a metering pump, at a given rate in 4 hours. After the completion of the dropping, the reactor inside was kept at 80 to 81° C. for 2 hours to conduct aging and then cooled to room temperature, followed by taking-out of the polymerization mixture.

995 g of n-hexane was placed in a 2-liter container. The container inside was cooled to 15° C. with stirring and this state was maintained. Thereinto was dropped 248 g of the polymerization mixture to separate out a copolymer. Stirring was conducted for 30 minutes and filtration was conducted to collect a wet cake. The wet cake was returned to the container; thereto was added 995 g of a mixed solvent of n-hexane and MEK, kept at 15° C. Stirring was conducted for 30 minutes for washing, after which filtration was conducted. This washing of wet cake was repeated once. The resulting wet cake was subjected to drying under reduced pressure at 60° C. or below for 8 hours, to obtain a white copolymer powder. The copolymer was measured for Mw, Mw/Mn, proportions of recurring units and proportions of terminal structures. The results of measurements are shown in Table 1.

To 100 parts by weight of the copolymer obtained were added the following additives and solvents of the following amounts to prepare a resist composition.

(1) Component (X): 4-methylphenyldiphenylsulfonium nonafluorobutanesulfonate (3.5 parts by weight)

(2) Component (Y): triethanolamine (0.2 part by weight)

(3) Component (Z): Surflon S-381 (produced by Seimi Chemical) (0.1 part by weight)

(4) A mixed solvent of propylene glycol monomethyl ether acetate (450 parts by mass) and ethyl lactate (300 parts by mass)

The resist composition was measured for tan θ and conducted for simulation of DOF, Eop and EL. The results are shown in Table 2.

### Example 3

An operation was conducted in the same manner as in Example 2 except that the “feed solution” was changed to a mixture of 98.8 g of MEK, 33.58 g of monomer M (A), 21.84 g of monomer Ga (C), 15.69 g of monomer 0 (D), 3.60 g of chain transfer agent V (F) and 0.72 g of polymerization initiator I. The copolymer obtained was measured for Mw, Mw/Mn, proportions of recurring units and proportions of terminal structures. The results of measurements are shown in Table 1. The resist composition obtained was measured for tan θ and conducted for simulation of DOF, Eop and EL. The results are shown in Table 2.

### Comparative Example 1

An operation was conducted in the same manner as in Example 2 except that the amount of the polymerization initiator I was changed to 4.62 g and no chain transfer agent V was used. The copolymer obtained was measured for Mw, Mw/Mn, proportions of recurring units and proportion of terminal structure. The results of measurements are shown in Table 1. The resist composition obtained was measured for tan θ and conducted for simulation of DOF, Eop and EL. The results are shown in Table 2.

### Comparative Example 2

An operation was conducted in the same manner as in Example 2 except that the amount of the polymerization initiator I was changed to 0.28 g and the chain transfer agent V was replaced by 4.28 g of chain transfer agent N synthesized according to Example 4 of JP-A-2004-292428. The copolymer obtained was measured for Mw, Mw/Mn, proportions of recurring units and proportions of terminal structures. The results of measurements are shown in Table 1. The resist composition obtained was measured for tan θ and conducted for simulation of DOF, Eop and EL. The results are shown in Table 2.

TABLE 1

| | GPC | | | | | | | Terminal | | |
|---|---|---|---|---|---|---|---|---|---|---|
| | | Mw/ | Recurring units | | | | | structure(s) | | |
| | Mw | Mn | G | Ga | M | O | Oa | V | N | I |
| Ex. 2 | 6760 | 1.57 | 41.4 | — | 39.5 | — | 19.1 | 3.0 | — | 0.3 |
| Ex. 3 | 6210 | 1.63 | — | 38.5 | 41.0 | 20.5 | — | 2.8 | — | 0.6 |
| Comp. | 6880 | 1.68 | 41.2 | — | 39.2 | — | 19.6 | — | — | 3.1 |
| Ex. 1 | | | | | | | | | | |
| Comp. | 6550 | 1.59 | 41.6 | — | 39.5 | — | 18.8 | — | 2.7 | 0.5 |
| Ex. 2 | | | | | | | | | | |

TABLE 2

| | | Compo. | Compo. | Compo. | | | | | |
|---|---|---|---|---|---|---|---|---|---|
| | Copolymer | (X) | (Y) | (Z) | Solvent | | | | |
| | (mass | (mass | (mass | (mass | (mass | | DOF | Eop | EL |
| | parts) | parts) | parts) | parts) | parts) | tan θ | (μm) | (mJ/cm²) | (mJ/cm²) |
| Ex. 2 | 100 | 3.5 | 0.2 | 0.1 | 750 | 33.3 | 0.80 | 11.7 | 1.2 |
| Ex. 3 | 100 | 3.5 | 0.2 | 0.1 | 750 | 30.5 | 0.81 | 10.9 | 1.1 |
| Comp. | 100 | 3.5 | 0.2 | 0.1 | 750 | 16.7 | 0.69 | 6.5 | 0.7 |
| Ex. 1 | | | | | | | | | |
| Comp. | 100 | 3.5 | 0.2 | 0.1 | 750 | 21.8 | 0.74 | 9.1 | 0.9 |
| Ex. 2 | | | | | | | | | |

As indicated by the results of the above Examples and Comparative Examples, the resist compositions using a copolymer of the present invention as a base polymer are clearly superior in tan θ and DOF, as compared with conventional techniques.

### INDUSTRIAL APPLICABILITY

By using the copolymer for semiconductor lithography and resist composition of the present invention, there can be obtained a lithography pattern superior in lithography properties such as development contrast, DOF and the like.

1. A copolymer for semiconductor: lithography, comprising:
at least, a recurring unit (A) having a structure wherein an alkali-soluble group has been protected with an acid-dissociating, dissolution-suppressing group, and
a terminal structure (F) represented by the following formula (F): 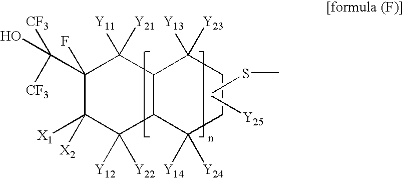
(wherein X₁ and X₂ are each independently a hydrogen atom, a halogen atom or a hydrocarbon group of 1 to 4 carbon atoms which may be substituted with halogen atom; Y₁₁ to Y₁₄ are a hydrogen atom, or an ether bond or a hydrocarbon bond of 1 to 2 carbon atoms, each formed between Y₁₁ and Y₁₂ or between Y₁₃ and Y₁₄; Y₂₁ to Y₂₅ are each independently a hydrogen atom or a hydrocarbon group of 1 to 4 carbon atoms; and n is an integer of 0 or 1).

2. A copolymer for semiconductor lithography as defined in claim 1, comprising a recurring unit (C) having a lactone structure.

3. A copolymer for semiconductor lithography as defined in claim 1, comprising a recurring unit (D) having an acid-stable, alicyclic hydrocarbon group.

4. A copolymer for semiconductor lithography as defined in claim 1, wherein the recurring group (A) having a structure wherein an alkali-soluble group has been protected with an acid-dissociating, dissolution-suppressing group, is represented by the following formula (A): 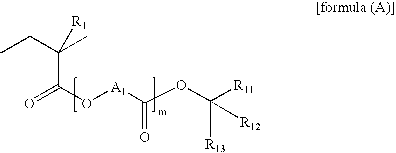
(wherein R₁ is a hydrogen atom or a hydrocarbon group of 1 to 4 carbon atoms; R₁₁ is a hydrocarbon group of 1 to 4 carbon atoms; R₁₂ and R₁₃ are each independently a straight chain or branched chain hydrocarbon group of 1 to 12 carbon atoms, or an alicyclic hydrocarbon group having a single ring or bridge-containing ring, or, R₁₂ and R,₃ bond to each other to form an alicyclic hydrocarbon group having a single ring or bridge-containing ring of 5 to 12 carbon atoms; or, R₁₁ and R₁₂ are each a hydrogen atom or a hydrocarbon group of 1 to 4 carbon atoms, and R₁₃ is an oxy group substituted with a straight chain or branched chain hydrocarbon group of 1 to 12 carbon atoms or with an alicyclic hydrocarbon group having a single ring or bridge-containing ring; A₁ is an alicyclic hydrocarbon group having a bridge-containing ring of 7 to 12 hydrocarbons; and m is an integer of 0 or 1).

5. A copolymer for semiconductor lithography as defined in claim 1, wherein the recurring unit (C) is represented by the following formula (C): 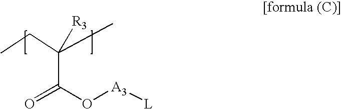
wherein R₃ is a hydrogen atom or a hydrocarbon group of 1 to 4 carbon atoms; A₃ is a single bond, or an alicyclic hydrocarbon group having a single ring or bridge-containing ring of 5 to 12 carbon atoms; L is a lactone structure represented by the following general formula (L): 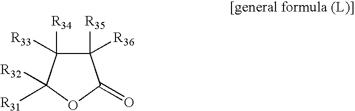
(wherein any one or two of R₃₁ to R₃₆ are connecting groups with A₃ of the general formula (C) and the remainder are each a hydrogen atom or a hydrocarbon group or alkoxyl group of 1 to 4 carbon atoms); and A₃ and L bond to each other via the above-mentioned one or two connecting groups}.

6. A copolymer for semiconductor lithography as defined in claim 1, wherein the recurring unit (D) is represented by the following formula (D): 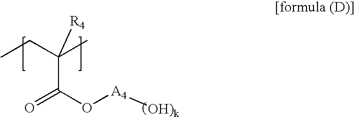
(wherein R₄ is a hydrogen atom or a hydrocarbon group of 1 to 4 carbon atoms; A₄ is an alicyclic hydrocarbon group having a bridge-containing ring of 7 to 12 carbon atoms, which may be substituted with halogen atom; and k is an integer of 0 to 3).

7. A composition for semiconductor lithography, comprising a copolymer as defined in claim 1 and a radiation-sensitive, acid-generating agent.

8. A thiol compound represented by the following formula (f): 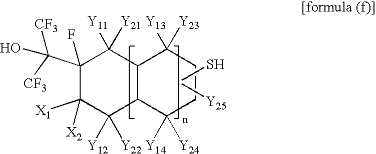
(wherein X₁ and X₂ are each independently a hydrogen atom, a halogen atom or a hydrocarbon group of 1 to 4 carbon atoms which may be substituted with halogen atom; Y₁₁ to Y₁₄ are a hydrogen atom, or an ether bond or a hydrocarbon bond of 1 to 2 carbon atoms, each formed between Y₁₁ and Y₁₂ or between Y₁₃ and Y₁₄; Y₂₁ to Y₂₅ are each independently a hydrogen atom or a hydrocarbon group of 1 to 4 carbon atoms; and n is an integer of 0 or 1).

9. A process for producing a copolymer for semiconductor lithography as defined in claim 1, which comprises conducting radical polymerization using, as a chain transfer agent, a thiol compound represented by the formula (f) of claim 8.
